(19) United States
(12) Patent Application Publication
(10) Pub. No.: US 2004/0107945 A1
(43) Pub. Date: Jun. 10, 2004

(54) Engine control method responsive to cylinder misfire detection

(76) Inventor: Kok Seng Yeo, Singapore (SG)

Correspondence Address: JIMMY L. FUNKE, DELPHI TECHNOLOGIES, INC., Legal Staff Mail Code: CT10C, P.O. Box 9005, Kokomo, IN, 46904-9005, US

(21) Appl. No.: 10/314,617

(22) Filed: Dec. 9, 2002

(51) Int. Cl. F02M 51/00

(52) U.S. Cl. 123/479; 123/481

(57) ABSTRACT

A control for a multi-cylinder internal combustion engine reduces exhaust emissions and prevents catalytic converter damage due to detected cylinder misfiring. The engine cylinders are individually monitored for misfiring, and when misfiring is detected in a given cylinder, fueling for that cylinder is suspended and the intake and exhaust valves for that cylinder are maintained closed to trap the unburned air/fuel charge for a predetermined number of engine cycles or until the mixture is ignited. If several successive air/fuel charges in a given cylinder fail to ignite using this procedure, the intake and exhaust valves for that cylinder are maintained closed to disable the cylinder until the engine can be serviced.

### TECHNICAL FIELD

This invention relates to the control of an internal combustion engine, and more particularly to an engine control method for reducing engine exhaust emissions and preventing catalytic converter damage due to engine misfiring.

### BACKGROUND OF THE INVENTION

It is well known that misfiring in an internal combustion engine will increase engine exhaust emissions, and that sustained misfiring can increase the catalytic converter temperature to a level that permanently damages the converter. For this reason, engine controllers are commonly programmed to detect engine misfiring (by identifying certain engine speed perturbations, for example), and to illuminate a diagnostic indicator when the detected misfiring exceeds a specified rate or percentage. Additionally, the engine power can be reduced to a “limp home” level if the detected misfiring rate is deemed to be sufficiently high to damage the catalytic converter. However, such controls are not particularly effective at reducing exhaust emissions due to misfiring, and what is desired is a control that both prevents catalytic converter damage and effectively reduces engine exhaust emissions due to misfiring.

### SUMMARY OF THE INVENTION

The present invention is directed to an individual cylinder control for a multi-cylinder internal combustion engine that reduces exhaust emissions and prevents catalytic converter damage due to detected cylinder misfiring. According to the present invention, the engine cylinders are individually monitored for misfiring, and when misfiring is detected in a given cylinder, fueling for that cylinder is suspended and the intake and exhaust valves for that cylinder are maintained closed to trap the unburned air/fuel charge for a predetermined number of engine cycles or until the mixture is ignited. If several successive air/fuel charges in a given cylinder fail to ignite using this procedure, the intake and exhaust valves for that cylinder are maintained closed to disable the cylinder until the engine can be serviced.

### BRIEF DESCRIPTION OF THE DRAWINGS

FIG. 1 is a diagram of a motor vehicle powertrain including a multi-cylinder internal combustion engine system equipped with individual cylinder misfire sensors and a microprocessor-based engine control module (ECM) programmed according to this invention.

FIG. 2 is a diagram of a representative misfire sensor of FIG. 1.

FIG. 3 is a computer flow diagram representative of a software routine executed by the ECM of FIG. 1 in carrying out the method of this invention.

### DESCRIPTION OF THE PREFERRED EMBODIMENT

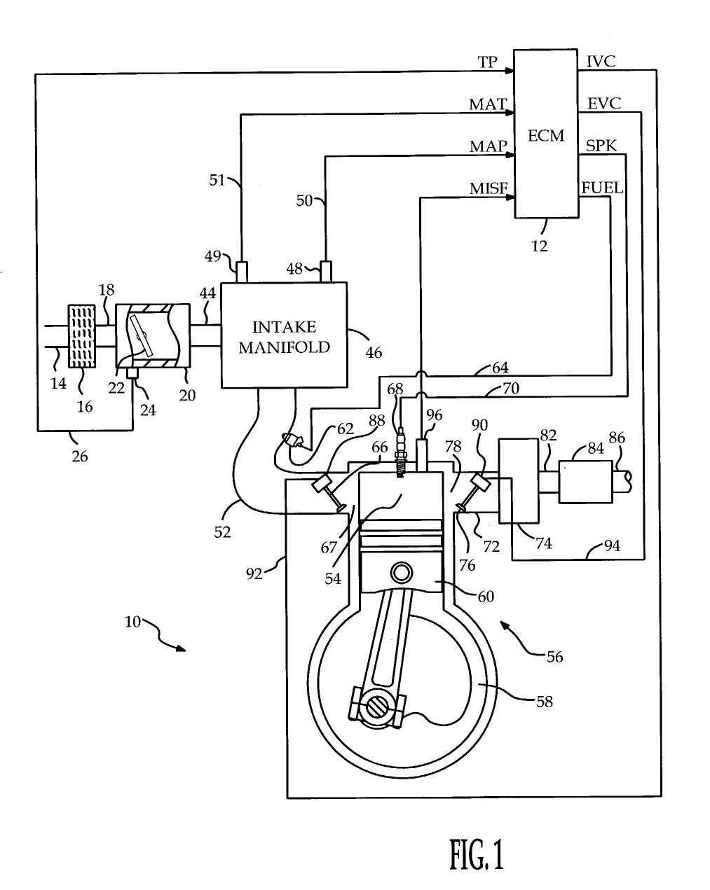

Referring to the drawings, and particularly to FIG. 1, the reference numeral 10 generally designates a four-stroke multi-cylinder internal combustion engine controlled by a microprocessor-based engine control module (ECM) 12. Inlet air at atmospheric pressure passes through fresh air inlet 14, air cleaner 16 and intake duct 18 into throttle body 20. A throttle plate 22 rotatably disposed in the throttle body 20 is manually or electronically positioned to vary restriction to the inlet air. The position of throttle plate 22 is detected by the sensor 24, which provides a throttle position signal (TP) to ECM 12 on line 26. Airflow out of throttle body 20 is coupled through intake duct 44 into the intake manifold 46. Conventional pressure and temperature transducers 48 and 49 are exposed to gas pressure in the intake manifold 46 and provide manifold absolute pressure and temperature signals (MAP, MAT) to ECM 12 via lines 50 and 51, respectively. Individual cylinder intake runners 52 couple intake manifold 46 to the combustion chambers 54 of respective engine cylinders 56, only one cylinder 56 being shown in FIG. 1. Each combustion chamber 54 is separated from the engine crankcase 58 by a respective piston 60 which engages the inside wall of the respective cylinder. A quantity of fuel is injected via conventional fuel injector 62 in response to a fuel injection command signal (FUEL) from ECM 12 on line 64.

In normal operation, the injected fuel mixes with the inlet air and is drawn into the combustion chamber 54 during an intake event when an electrically activated intake valve 66 opens an intake port 67. The air-fuel mixture is ignited in the combustion chamber 54 during a combustion event initiated by a timed spark across the spaced electrodes of spark plug 68, which is controlled by ECM 12 via a spark control signal (SPK) on line 70. Gasses produced during the combustion event are exhausted through exhaust runner 72 to exhaust manifold 74 during an exhaust event when all electrically activated exhaust valve 76 opens an exhaust port 78. The exhaust gasses pass through the exhaust manifold 74 to an exhaust duct 82 leading to catalytic converter 84 and tailpipe 86. In the illustrate embodiment, the intake and exhaust valves 66 and 76 are electrically activated by respective electric servos 88 and 90. Various electric drive mechanisms suitable for this purpose are known in the art, and the exact nature of servos 88 and 90 is not particularly important to the present invention. As indicated in FIG. 1, the ECM 12 develops a control signal IVC on line 92 for activating the intake valve servo 88, and a control signal EVC on line 94 for activating the exhaust valve servo 90.

Engine misfiring occurs when the air-fuel mixture supplied to combustion chamber 54 fails to ignite during a combustion even. This may occur for a number of different reasons, and in a conventional system, the unburned fuel is passed into the exhaust manifold 74 and catalytic converter 84 along with the combustion gasses from the other cylinders. The misfiring increases the hydrocarbon concentration in the exhaust gas emissions, and if sustained, can cause permanent heat-related damage to the catalytic converter 84. For this reason, engine control units are commonly programmed to detect engine misfiring, usually by identifying certain engine speed perturbations, and to illuminate a diagnostic indicator when the detected misfiring exceeds a specified rate or percentage. However, the extent of the increased emissions and potential damage to the catalytic converter 84 depends on how soon the engine is serviced. The present invention avoids these problems by individually monitoring the engine cylinders for misfiring, and by controlling the fuel, spark and valves for a misfiring cylinder so that the impact on the emissions and catalytic converter 84 are minimized. Referring to FIG. 1, each engine cylinder 56 is equipped with a misfire sensor 96 that is in communication with the respective combustion chamber 54, and supplies an electrical signal MISF to ECM 12 on line 98 for detecting misfires. When ECM 12 detects misfiring in a given cylinder 56, fueling for that cylinder is suspended and the intake and exhaust valves 66, 76 for that cylinder arc maintained closed to trap the unburned air/fuel charge in the respective combustion chamber 54 for a predetermined number of engine cycles or until the mixture is ignited. If several successive air/fuel charges in a given cylinder 56 fail to ignite using this procedure, the intake and exhaust valves 66, 76 are closed to disable the cylinder 56 until the engine 10 can be serviced to remedy the misfiring.

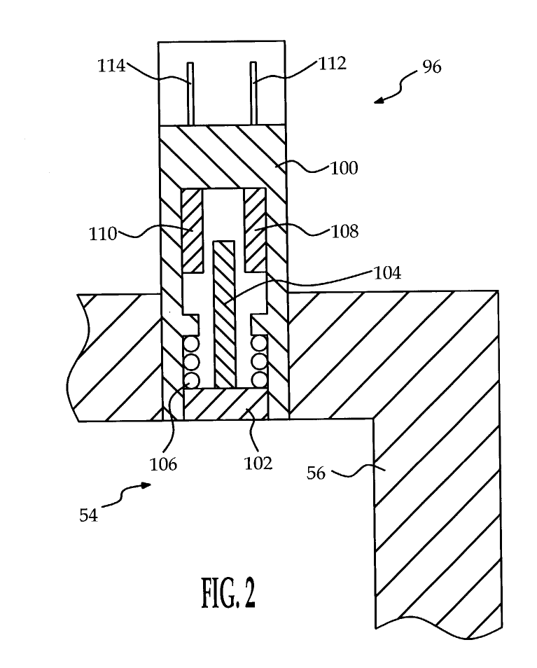

A representative misfire sensor 96 is depicted in FIG. 2, where the reference numerals 56 and 54 designate a cylinder and combustion chamber as in FIG. 1. The sensor housing 100 encloses a piston 102 and connecting rod 104 that are urged by spring 106 toward a limit position as shown in FIG. 2. A portion of the outboard end of rod 104 is disposed between a pair of sensing elements 108, 110 having an electrical characteristic (inductance, capacitance or resistance) that changes with the axial position of rod 104. The sensing elements 108, 110 are connected to terminals 112, 114 that are coupled to ECM 12 via line 98. The spring 106 is sufficiently strong to prevent movement of the piston 102 and rod 104 during a normal compression stroke with no combustion, but sufficiently weak to allow outboard axial movement of the piston 102 and rod 104 due to a combustion event in the chamber 54. Thus, a combustion event is detected by a change in the electrical characteristics of sensing elements 108, 110, and a misfire is detected the absence of such a change during a specified window of time relative to the spark event for that cylinder.

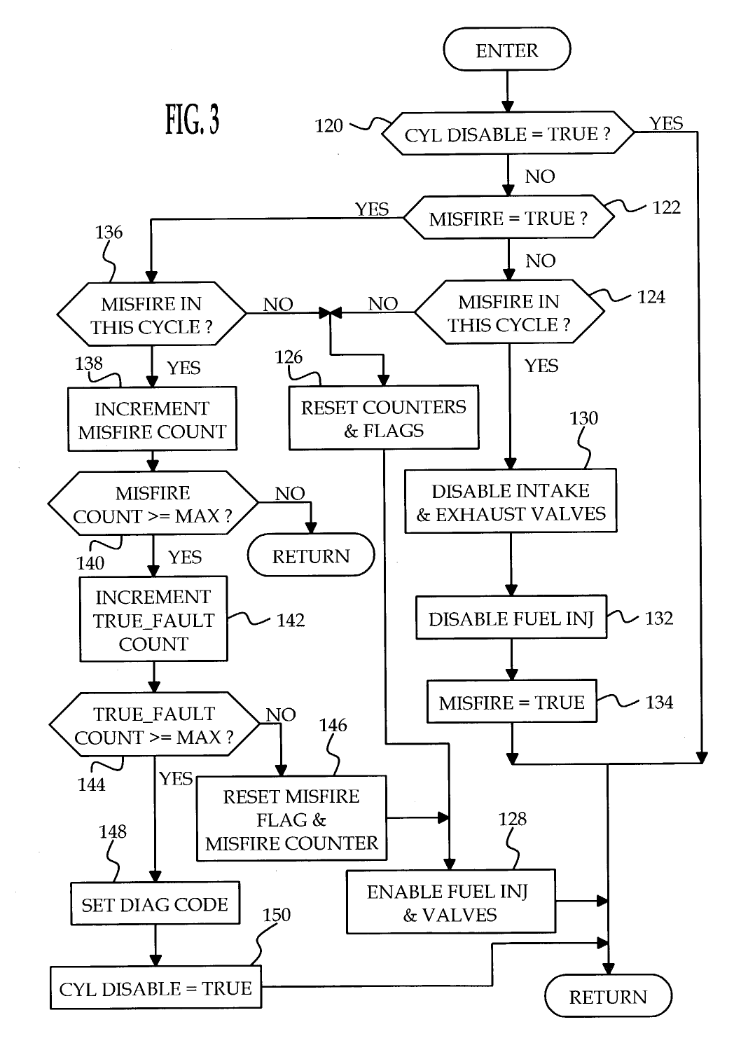

The flow diagram of FIG. 3 represents a software routine executed by ECM 12 for each engine cylinder 56 during a time window in which a combustion event is expected. The routine utilizes two flags, both of which are initialized to FALSE. As explained below, the routine sets the MISFIRE flag to TRUE when a misfire is detected in the cycle, and to FALSE when no misfire is detected. The routine sets the CYL DISABLE flag to TRUE when a persistent misfire condition is detected.

In each execution of the routine, the block 120 determines if the CYL DISABLE flag is TRUE. If so the remainder of the routine is skipped; if not, the block 122 determines if the MISFIRE flag is TRUE, indicating that a misfire was detected in the previous combustion cycle of the cylinder currently begin monitored. Initially, of course, blocks 120 and 122 will both be answered in the negative, and the block 124 is executed to detect if a misfire has occurred in the current cycle, based on the output of the misfire sensor 96. If not, the blocks 126 and 128 are executed to reset the MISFIRE and TRUE_FAULT counters to zero, to set the MISFIRE and CYL DISABLE flags to FALSE, and to enable normal fueling and valve activation. If a misfire did occur, the blocks 130, 132 and 134 are executed to maintain the intake and exhaust valves 66, 76 closed by disabling their activation, to disable fuel injection at the cylinder, and to set the MISFIRE flag to TRUE. In the next combustion stroke of that cylinder, the spark plug 68 will be activated as usual, and the routine is executed again to determine if the air/fuel mixture trapped in the combustion chamber 54 ignited. Referring to the routine, the block 129 will be answered in the affirmative, and the block 136 determines if a second misfire has been detected. If not, the blocks 126 and 128 are executed as explained above to reset the counters and flags and to enable normal fueling and valve activation. However, if a second misfire is detected, the block 138 increments the MISFIRE counter. The block 140 compares the MISFIRE counter to a reference count (MAX) such as three; if the number of consecutive misfires exceeds MAX, a true fault is logged by block 142 which increments the TRUE_FAULT counter. So long as the TRUE_FAULT counter is less than a reference count (MAX) such as three or four, as determined by block 144, the block 146 sets the MISFIRE flag to FALSE, resets the MISFIRE counter, and enables normal fueling and valve activation. If a misfire occurs in the same cylinder again (i.e., if the MISFIRE counter is incremented to MAX again), with no intervening combustion event, block 142 again increments the TRUE_FAULT counter, and if the TRUE_FAULT count exceeds MAX, the blocks 148 and 150 are executed to set a misfire diagnostic flag and the set the CYL DISABLE flag to TRUE. This notifies the driver of the fault, and maintains the misfiring cylinder in a disabled state (intake and exhaust valves closed, and no supplied fuel) until the CYL DISABLE flag is reset (when the engine is serviced, or at the next ignition cycle if desired).

In summary, the method of the present invention responds to detected engine misfiring in a way that significantly reduces the impact of the misfiring on both engine exhaust emissions and catalytic converter heating, and permits limp-home operability in the presence of persistent misfiring by disabling the misfiring cylinders, and allowing continued operation of the non-misfiring cylinders. While described in reference to the illustrated embodiment, it is expected that various modifications in addition to those mentioned above will occur to those skilled in the art. For example, misfiring may be detected by a different type of sensor than shown; a different valve actuating mechanism may be used, and so on. Thus, it will be understood that methods incorporating these and other modifications may fall within the scope of this invention, which is defined by the appended claims.

1. A control method for a multiple cylinder internal combustion engine subject to misfiring, comprising the steps of:
monitoring for misfiring in each of the cylinders;
when a misfire is detected in a given cylinder, suspending further fuel delivery to such cylinder and closing a combustion chamber of such cylinder to trap an air/fuel charge therein;
continuing to monitor for misfiring in the given cylinder in a subsequent engine cycle during which ignition of the trapped air/fuel charge is attempted; and
logging a misfiring condition if misfiring is detected in a predetermined number of successive engine cycles.

2. The control method of claim 1 including the steps of:
counting how many times misfiring is detected in the given cylinder;
resetting the count in response to ignition of said trapped air/fuel charge; and
logging the misfiring condition if the count reaches a predetermined count.

3. The control method of claim 1, including the step of:
if ignition of the trapped air/fuel charge occurs prior to logging a misfiring condition, ending the suspension of further fuel delivery to the given cylinder and opening said combustion chamber for admission of a new air/fuel charge.

4. The control method of claim 1, including the step of:
after logging the misfiring condition, ending the suspension of further fuel delivery to the given cylinder and opening said combustion chamber for admission of a new air/fuel charge.

5. The control method of claim 4, including the steps of:
counting how many times a misfiring condition is logged for the given cylinder;
resetting the count in response to ignition of an air/fuel mixture in the given cylinder; and
logging a failure of the given cylinder if the count reaches a predetermined count.

6. The control method of claim 5, wherein the suspension of further fuel delivery to such cylinder and the closing of said combustion chamber are maintained in response to the logging of a failure of the given cylinder.

7. The control method of claim 1, wherein said engine includes electrically activated intake and exhaust valves for each of the cylinders, and closing a combustion chamber of the given cylinder is achieved by activating the intake and exhaust valves for the given cylinder to a closed condition.

8. The control method of claim 1, including the step of:
providing a misfire sensor in each cylinder responsive to a pressure change due to ignition of an air/fuel mixture, where misfiring is detected by an absence of sensor response during an interval in which ignition of the air/fuel mixture is expected to occur.
